(19) United States
(12) Patent Application Publication
(10) Pub. No.: US 2022/0309175 A1
(43) Pub. Date: Sep. 29, 2022

(54) CONTENT MANAGEMENT TECHNIQUES FOR VOICE ASSISTANT

(71) Applicant: AIPEX Technologies, Inc., Carnation, WA (US)

(72) Inventors: Dana Young, Carnation, WA (US); David Nguyen, Bothell, WA (US)

(21) Appl. No.: 17/689,878

(22) Filed: Mar. 8, 2022

Related U.S. Application Data
(60) Provisional application No. 63/167,324, filed on Mar. 29, 2021.

(51) Int. Cl. G06F 21/62; G10L 15/22; G10L 15/18

(52) U.S. Cl. CPC G06F 21/6218; G10L 15/22; G10L 15/18

(57) ABSTRACT

A computer system defines a voice content management domain using a role-based access control model. The computer system defines category data structures each having an associated permission role, as well as containers with content item data structures that define voice content. The computer system grants permission to administrators to add, remove, or modify voice content in containers based on permission roles assigned to the administrators. The permission roles are associated with category data structures. The computer system publishes changes in content item data structures and aggregates the changed content items in a content package that includes the published changes for. Publication of the changes may include prioritizing changes initiated by administrators with higher-priority permission roles, such that conflicts between changes are resolved in favor of higher-priority roles. Illustrative content item schemas and voice menu design techniques are also described.

### CROSS-REFERENCE TO RELATED APPLICATION

This application claims the benefit of Provisional Application No. 63/167,324, filed Mar. 29, 2021, the entire disclosure of which is hereby incorporated by reference herein for all purposes.

### BACKGROUND

Voice-enabled virtual assistants or “voice assistants” (e.g., Siri, available from Apple Inc., Google Assistant, available from Google Inc., or Alexa, available from Amazon.com, Inc.) are typically geared towards general consumer use such as computer-assisted searching, purchasing items, and other general tasks. In a typical scenario, a user speaks a “wake word” to activate the voice assistant, followed by a question or command. In response, the voice assistant uses natural language processing (NLP) to parse the user's statement and query a database, or a collection of databases, to obtain a response to the question. The response is formulated in text that is output as a synthesized voice (e.g., via a smart phone or a voice-enable speaker (or smart speaker), such as the Echo, available from Amazon.com, Inc., or Google Home, available from Google Inc.).

As its name implies, NLP refers to processing of natural human language, within the broader context of automatic speech recognition (ASR). ASR includes basic processing such as automatic speech-to-text (STT) processing, in addition to more specialized processing, such as NLP. Natural language understanding (NLU) refers to more advanced processing of natural human language, within the broader context of NLP. NLP concepts that do not rise to the level of NLU include part-of-speech tagging, named entity recognition, text categorization, and syntactic parsing.

NLU is a subfield of artificial intelligence (AI), which involves breaking down human language into a machine-readable format. NLU concepts include semantic parsing, paraphrasing and summarization, natural language inference, and dialogue agents. NLU makes use of grammatical rules and common syntax to understand the meaning of text.

In order to be effective, applications based on NLU require prior knowledge of what may be asked by a user. For this reason, NLU is typically employed for a narrow range of general tasks that are generally applicable to a wide variety of users, such as Internet searching (e.g., for trivia, statistics, or other facts), playing music, making lists, placing calls, composing messages, updating calendars, or purchasing items.

On the other hand, there is an increasing need for voice technology in industry-specific applications. Examples include hospitality, in which a voice assistant may be deployed as a virtual concierge to provide specialized information and recommendations to guests. Other industries of interest include senior living, in which a companion assistant can share specific information about a facility's meal schedule, upcoming activities, announcements, or real estate, in which a virtual sales agent that can provide for unattended access to residences that are for sale or rent and guided tours explaining features available to new home buyers or apartment renters.

Yet, there are many technical challenges to deploying such technology in these contexts, one of which is to deliver curated content as opposed to general knowledge that may be of limited use in these contexts. Consider a scenario in which a user has recently arrived in a vacation rental home equipped with a voice-enabled speaker and voice assistant. The user is planning to watch a movie and wants to know if there is a home theater sound system available. In an attempt to find the sound system, the user may ask, “Where is the sound system?” This question has no useful responses without knowledge of the specific context of the question, as well as the features and layout of the home in which the question is asked. Therefore, a useful response would typically require specialized training and programming Such programming may allow a voice assistant to interpret “Where is the sound system?” as a request about the presence and location of the sound system in that rental home, and to provide a response such as, “The sound system is located in the cabinet near the TV in the living room.” However, in order to provide this functionality, the voice assistant must be programmed to understand the context of the user's question, as well as provide the correct information to respond to the question.

Although programming of this nature is achievable, it is also time-consuming and expensive and raises several technical problems to overcome. For example, a software developer who knows generally what a user may ask must expand the potential ways the user's intent may be verbalized and train the NLP engine to handle them effectively. In the situation illustrated above, a usable system should be able to handle “Where is the sound system?” as well as variations such as, “Tell me where the home theater system is.” Yet, this effort would be wasted for deployment in homes that lack a home theater system. Furthermore, if additional needs arise, the software must be reprogrammed to handle them. If a new projector is installed in a media room in the rental home, the software must be reprogrammed to not only recognize new vocabulary such as “projector,” but to recognize and answer common questions about it, such as how to turn it on and off. Thus, there are substantial technical barriers to implementing and maintaining a system of this nature.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computer system having access to a database of curated content receives, via a voice assistant, one or more content requests, analyzes the content request(s), and outputs curated voice content in response to the content request(s). The database includes content item data structures with one or more tags and one or more component attributes. The computer system determines whether curated content related to the content request(s) is available in a content item data structure by extracting terms from the content request(s) and comparing the extracted terms with the tag(s) and the component attribute(s). The computer system outputs voice content from the content item data structure based on the results of these comparisons. The computer system selects content associated with the component attribute(s) for inclusion in the output content, and the outputted content may include one or more component descriptions associated with the component attribute(s). The outputted content may further include a base description of the content item data structure. The content request(s) may be prompted in some circumstances by a recommendation engine of a voice assistant.

In another aspect, a computer system defines a voice content management domain for management of voice content for voice assistant devices using a role-based access control mode. The computer system defines category data structures each having an associated permission role for the voice content management domain, as well as containers with content item data structures that define the voice content for the voice content management domain. The containers are associated with the category data structures. The computer system grants permission to one or more administrators to add, remove, or modify the voice content in at least one of the containers based on permission roles assigned to the administrator(s). The permission roles are associated with a category data structure to which the at least one container is assigned. The computer system is further configured to publish changes in one or more of the content item data structures and to aggregate the changed content item data structures in a content package that includes the published changes for one or more of the voice assistant devices. Publication of the changes may include prioritizing changes initiated by administrators with higher-priority permission roles, such that conflicts between changes are resolved in favor of higher-priority roles.

The computer system may use a category tree to define a hierarchy of the category data structures. The hierarchy may include multiple levels. In an illustrative arrangement, the hierarchy includes at least a first level and a second level higher than the first level, and permission roles associated with the category data structures in the second, lower level are inherited by the category data structures in the first, higher level.

Containers may include references to one or more global content item data structures, in which changes to a single global content item data structure that originate from a single source may be propagated across all containers that reference the global content item data structure.

In another embodiment, a computer system implements a voice menu tree by defining a set of tags for menu content items, assigning each tag to a tag category, and assigning each tag category a parent tag category that aggregates menu options into groupings. The menu content items with the tags are presented at leaf level of the voice menu tree. As more menu content items and tag categories are added to the voice menu tree, the voice menu can become complex and difficult to navigate. In order adapt the size and arrangement of the voice menu tree for greater usability and efficiency, the computer system executes a menu folding process that includes removing from the menu structure any leaf-level tag category that does not have a menu content item with a tag that belongs to that tag category. The menu folding process may further include organizing remaining leaf-level tag categories into sibling groups that have the same parent tag category; assigning content items in at least one of the sibling groups to its corresponding parent tag category; and removing one or more child tag categories from the at least one sibling group from the menu structure. The steps of assigning the content items in the at least one sibling group to its corresponding parent tag category and removing the one or more child tag categories from the menu structure may be performed in response to comparing the number of content items in the at least one sibling group with a threshold number.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a computer system in which described embodiments may be implemented;

FIG. 2 is a flow chart of an illustrative process for obtaining curated voice content in response to content requests, in accordance with embodiments described herein;

FIG. 3 is a flow chart of an illustrative process for management of voice content for voice assistant devices using a role-based access control model in accordance with embodiments described herein;

FIG. 4 is a diagram of an illustrative category tree for voice content that may be used with a role-based access control model in accordance with embodiments described herein;

FIGS. 5 and 6 are flow charts of illustrative processes for defining and adjusting a dynamic voice menu structure, respectively, in accordance with embodiments described herein;

FIG. 7 is a diagram of an illustrative voice menu structure that be defined and adjusted in accordance with embodiments described herein; and

FIG. 8 is a block diagram that illustrates aspects of an illustrative computing device appropriate for use in accordance with embodiments of the present disclosure.

### DETAILED DESCRIPTION

In the following description, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein. The illustrative examples provided herein are not intended to be exhaustive or to limit the claimed subject matter to the precise forms disclosed.

In some embodiments, a Voice Content Management Platform (VCMP) is implemented as a Content Management System (CMS) tailored to voice content. Described embodiments include systems and techniques that allow a VCMP to define, organize and manage curated content that will be delivered through a voice assistant. In some embodiments, content items are aggregated in a content package and delivered to a voice assistant. A content item (CI) refers to a specific piece of curated information that relates to a topic that may be of interest to a user. For example, a CI in a hospitality use case might be a particular attraction available to hotel guests in a local area. In an illustrative scenario, a content package is used to facilitate context-specific interactions with a user at a given device location. In such a scenario, the curated information contained in a content package is specific and appropriate to one or more devices at that device location.

In one embodiment, a computer system defines a voice content management domain for management of voice content for voice assistant devices using a role-based access control model. The computer system defines category data structures each having an associated permission role for the voice content management domain, as well as containers with CI data structures that define the voice content for the voice content management domain. The containers are associated with the category data structures. The computer system grants permission to one or more administrators to add, remove, or modify the voice content in at least one of the containers based on permission roles assigned to the administrator(s). The permission roles are associated with a category data structure to which the at least one container is assigned. The computer system is further configured to publish changes in one or more of the CI data structures and to aggregate the changed CI data structures in a content package that includes the published changes for one or more of the voice assistant devices. Publication of the changes may include prioritizing changes initiated by administrators with higher-priority permission roles, such that conflicts between changes are resolved in favor of higher-priority roles.

In another embodiment, a computer system having access to a database of curated content analyzes content requests and outputs curated voice content in response to the content requests. The database includes CI data structures with one or more tags and one or more component attributes. The computer system determines whether curated content related to the content requests is available in a CI data structure by extracting terms from the content requests and comparing the extracted terms with the tags and the component attributes. The computer system outputs voice content from the CI data structure based on the results of these comparisons.

In another embodiment, a computer system implements a voice menu tree by defining a set of tags for menu CIs, assigning each tag to a tag category, and assigning each tag category a parent tag category that aggregates menu options into groupings. The menu CIs with the tags are presented at leaf level of the voice menu tree. As more menu CIs and tag categories are added to the voice menu tree, the voice menu can become complex and difficult to navigate. In order adapt the size and arrangement of the voice menu tree for greater usability and efficiency, the computer system executes a menu folding process that includes removing from the menu structure any leaf-level tag category that does not have a menu CI with a tag that belongs to that tag category. The menu folding process may further include organizing remaining leaf-level tag categories into sibling groups that have the same parent tag category; assigning CIs in at least one of the sibling groups to its corresponding parent tag category; and removing one or more child tag categories from the at least one sibling group from the menu structure. The steps of assigning the CIs in the at least one sibling group to its corresponding parent tag category and removing the one or more child tag categories from the menu structure may be performed in response to comparing the number of CIs in the at least one sibling group with a threshold number.

Described embodiments overcome technical problems of previous systems, as described in detail below.

### Illustrative Systems and Devices

The following section includes descriptions of illustrative systems and devices that may be used in accordance with described embodiments.

In some embodiments, to allow custom voice content to be defined without reprogramming the application, an interface is provided that can be accessed and used by a non-technical person. The interface can be provided as a web-based portal, with corresponding content stored in a database. An administrator (e.g., a property manager or owner) may access and provide contextual content via the portal with any suitable computing device, such as a smart phone, tablet, or a notebook or desktop computer that is connected to the Internet.

A client device (e.g., a smart speaker implementing a voice assistant) can then access the custom content to provide a customized interactive voice-based information retrieval experience for a given use case without extensive reprogramming of the system. In some embodiments, a fully dynamic information retrieval structure allows any number of items to be defined and organized uniquely to a given host or author's needs.

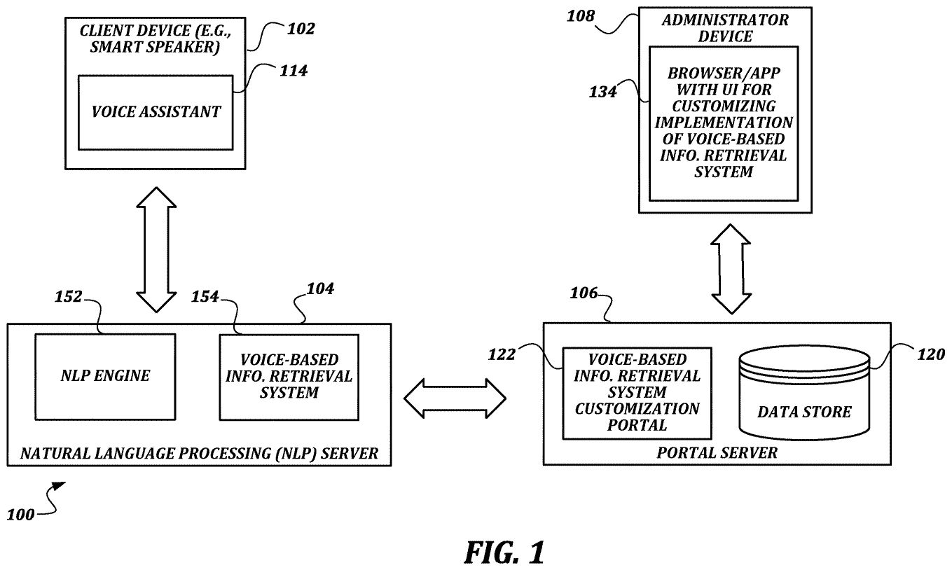

FIG. 1 is a block diagram of a computer system in which described embodiments may be implemented. In the example shown in FIG. 1, the system 100 includes a client device 102 (e.g., a smart speaker), a natural language processing (NLP) server 104, a portal server 106, and an administrator device 108. The client device 102 implements a voice assistant 114 that communicates with the NLP server 104, which implements an NLP engine 152 and a voice-based information retrieval system 154.

In described embodiments, the voice-based information retrieval system 154 is used as a virtual concierge service for real property such as houses, buildings, hotels, resorts, parks, event spaces, shopping malls, rental properties (e.g., apartments, rental homes) or combinations thereof. In an embodiment, the client device is located on the real property in question. Alternatively, the client device may be located elsewhere (e.g., at a leasing or sales office). Although examples described herein refer to use cases involving rental properties, it should be understood that the technology described herein can be easily applied to privately owned properties (e.g., for personal guests of a homeowner), public properties, or private properties that are accessible to the public, such as resorts and shopping malls. As another example, the technology described herein can be used in other scenarios, such as a tool for real estate agents, brokers, or property owners listing a property for sale or rent. In such a scenario, the virtual concierge service or aspects thereof may be used to assist prospective property buyers, renters, real estate agents, apartment brokers, or the like to learn more about a property, e.g., as a virtual sales agent or leasing agent.

In some embodiments, a voice assistant is implemented as a digital assistant that uses voice recognition, speech synthesis, and natural language processing (NLP) to provide a service through a particular application. Common commercial voice assistants are Amazon Alexa and Google Assistant, for example. A hardware device is used to host a voice assistant. Examples are smart phones and smart speakers, such as the Amazon Echo or the Google Nest Audio families of products. A device location refers to a location (e.g., a hotel room, a vacation or commercial rental property, an apartment in a senior living facility, or the like) for one or more devices that implement a voice assistant. There is often a one-to-one relationship between a device location and a device, but that is not always the case.

The NLP engine 152 provides functionality for natural language understanding (NLU) of at least some speech input provided to the voice assistant 114 for interacting with the voice-based information retrieval system 154. The NLP server 104 also communicates with the portal server 106, which implements a customization portal 122 for the voice-based information retrieval system and includes a data store 120. The portal server 106 also communicates with an administrator device 108, which provides an interface 134 (e.g., via a web browser or custom application) for customizing an implementation of the voice-based information retrieval system.

Many alternatives to the arrangement shown in FIG. 1 are possible. For example, although a single client device and a single administrator device are shown for ease of illustration, it should be understood that the system can be easily extended to accommodate multiple client devices and multiple implementations of the voice-based information retrieval system, as well as multiple administrator devices. Multiple client devices may access the same implementation of the voice-based information retrieval system, or such devices may access different implementations (e.g., for different properties). Multiple administrator devices may access the same customization portal to customize the same implementation of the voice-based information retrieval system, or such devices may access different portals to customize different implementations. As another example, although the client device 102 is shown as implementing the voice assistant 114 for purposes of illustration, it should be understood that functionality of the voice assistant may be distributed across multiple computing devices, such as where the NLP engine 152 includes NLP functionality for the voice assistant. As another example, although the NLP server 104 and the portal server 106 are illustrated as single servers in FIG. 1, it should be understood that the functionality provided by these each of these servers may, alternatively, be distributed across multiple computing devices. In one illustrative scenario, the functionality of the portal server 106 may be provided by a first server (or a set of multiple servers) that implements the customization portal 122 and a second server (or a set of multiple servers) that hosts the data store 120. In another illustrative scenario, the functionality of the NLP server 104 may be provided by a first server (or set of multiple servers) that implements the NLP engine 152 and a second server (or set of multiple servers) that hosts the voice-based information retrieval system 154.

### Illustrative Content Item Schema

In some embodiments, a schema for content items (CIs) facilitates user-friendly interactions with a voice assistant when presenting curated information. In an embodiment, the schema enables user experiences such as the ability to ask specific follow up questions about a topic or receive personalized recommendations from a recommendation engine based on user feedback. In some embodiments, the schema facilitates presentation of scheduled voice content, such as by defining a schedule and recurrence in such a way as to control whether a given CI that is included in a content package is eligible for delivery to a user. Such embodiments may be used in implementations of advanced voice content features, such as the delivery of different content based on seasonality, or in implementations of voice content management features, such as the ability to define events only once that may take place annually or otherwise re-occur, or to include pre-defined content that changes daily or on other time schedules.

Described embodiments of the described CI schema solve one or more technical problems relating to efficient and effective implementations of voice assistants. One technical problem inherent to delivering information via a voice assistant is that two considerations are working in opposing directions. On one hand, a CI with more detail is more likely to include information that satisfies a user's information request than an abbreviated description. On the other hand, a user may get impatient or frustrated if a voice assistant presents a CI to the user that contains too much detail. To balance these considerations, some embodiments are designed to deliver specific information the user is interested in.

In embodiments described herein, a CI schema provides technical solutions to such problems. Administrators or other content providers can provide a brief overview of a topic without including all detail. Then, a large set of additional information can be made available in response to a user's follow up questions. This provides the ability to deliver a wide range of information about a CI, while at the same time keeping the length of the voice responses brief. In this context, a topic represents a subject of interest. For example, in a hospitality use case, topics may include recommendations for specific types of food or entertainment in a local area. In a senior living use case, topics may include scheduled activities, or the menu for meals. In a real estate use case, topics may include options for new construction of a home, such as countertops or roofing options.

An illustrative CI schema is now described with reference to illustrative configurations and usage scenarios. The illustrative CI schema includes several elements, which are described in further detail below.

A CI Title defines the name of a CI. Tags are descriptive terms associated with a CI which can be recognized by the voice assistant system. In some embodiments, tags operate as described in U.S. patent application Ser. No. 16/802,395, which is incorporated herein by reference. In some embodiments, tags can be used to disaggregate or decouple CIs from an NLU model. In such embodiments, CIs do not need to be identified and pre-trained in the NLU model. In such embodiments, tags act as an intermediary, a separate entity that connects unique custom content to a set of words and phrases that are part of the NLU model. This approach allows the system to provide a natural-feeling conversation for the user, while also providing the flexibility to present custom content to a user without specialized NLU training. This approach also provides a significant increase in flexibility and utility.

In some embodiments, an NLU engine is pre-trained on a set of words and phrases, and a tag is connected to that set of words and phrases in the model. It is also connected to a CI. By establishing these connections, a word or phrase of the set that is spoken by the user will result in the associated CI being delivered in response. This creates broad flexibility and utility for an administrator, allowing them to establish Cis that do not need to be included in the NLU model, in such a way that unique content (including proper nouns) can be delivered to a user through a voice assistant with no NLU training required. Multiple tags can be associated with a single CI. Similarly, a given tag can be used for multiple CIs.

An attribute is a logical construct similar to a tag. In an embodiment, both attributes and tags act as an intermediary between an NLU model and CIs. This allows CIs to be decoupled from an NLU model in such a way that CIs do not need to be identified and pre-trained in the NLU model.

In an embodiment, attributes and tags have separate and distinct purposes. While tags are assigned to CIs, attributes are assigned to CI components (described below). Even though they are not directly assigned to a CI, any attribute assigned to a component is inherited by the parent CI. In an embodiment, attributes are selected from a pre-defined list available to an administrator. Attributes are used to identify a particular aspect of a CI. For example, in a hospitality use case, a “Parking” attribute could be applied to a component, and the component description could describe the parking options at a local attraction. Attributes may optionally have a set of values.

The following are examples of attributes that may be used in a hospitality implementation as described, with illustrative values (if applicable) in parentheses:
On-property
Indoor
Outdoor
Duration (less than 2 hrs; 2-4 hrs; more than 4 hrs)
Activity Level (easy; moderate; high)
Free/No cost
Intensity Level (relaxing; medium; thrill-seeking)
Exhibit
Tour
Live Show
Dinner Included
Handicap accessible
Guided Activity
Kid-friendly
Family-friendly
Pet-friendly
Walker-friendly
Adult only
Romantic
Open 24/7
Hours of Operation
Parking
Open Year-Round
Lockers Available
Food allowed
Waiting Time
Price
Group Size
Age Range

A base description is content that provides a typically brief description or overview of the CI. The base description is associated with content that can be presented by a voice assistant in response to questions or prompts about the CI.

In an embodiment, components are defined in terms of component attributes, component descriptions (a brief description of the specific aspect of the CI the component covers), and component Include/Exclude flags. An administrator can optionally define any number of CI components, which may have one or more assigned attributes.

The base description and component description elements are associated with content that can be presented by a voice assistant in response to questions or prompts.

In an embodiment, when a user asks a question or utters a prompt that corresponds with a tag, the CI(s) associated with that tag are identified to be included in the voice assistant's response to the user. When this occurs, the CI's base description, and one or more component descriptions may be aggregated together with the base description to form the content of the response, depending on whether they are flagged as “Include” or “Exclude.” In an embodiment, whether a component description is included or excluded from the full description, each component description is eligible to be delivered as stand-alone voice content in a response to a user request.

Table 1 below includes elements of a first configuration of the illustrative CI schema.

TABLE 1
First Configuration

| Element | Value |
|---|---|
| CI Title | Swimming Pool |
| CI Tag | Pool |
| CI Base Description | “Come join us down at the pool! it is one |
| | of our most popular amenities.” |
| CI Component 1 Attribute | Kid-Friendly |
| CI Component 1 | “Our pool is kid friendly, with an |
| Description | extended shallow area for wading.” |
| CI Component 1 Include/ | Include |
| Exclude Flag | |
| CI Component 2 Attribute | Handicap Accessible |
| CI Component 2 | “The pool is equipped with an ADA |
| Description | compatible swimming pool lift. Just ask for |
| | assistance where you pick up towels.” |
| CI Component 2 Include/ | Exclude |
| Exclude Flag | |
| CI Component 3 Attribute | Hours of Operation |
| CI Component 3 | “The swimming pool is open from 9am until |
| Description | 7pm, 7 days a week.” |
| CI Component 3 Include/ | Include |
| Exclude Flag | |

In a first scenario involving the first configuration in Table 1, a user begins with a basic prompt about a topic, and then asks a follow-up question. The voice assistant notes the presence of the “Pool” tag in the initial prompt from the user, invokes the “Swimming Pool” CI, and responds with the base description. Because Component 1 and Component 3 are both set to “Include,” these descriptions are also output by the voice assistant along with the base description, even though the user did not ask about those components specifically. Component 2 is set to “Exclude” but can still be accessed when its corresponding attribute (“Handicap Accessible”) is invoked by the user in a follow up question or prompt. Once the Swimming Pool CI has been invoked, the system can respond to follow-up questions even where the pool is not mentioned specifically (e.g., by replacing the pronoun “it”), as in the interaction below.

User: “Tell me about the pool”

Voice Assistant: “Come join us down at the pool! it is one of our most popular amenities. Our pool is kid friendly, with an extended shallow area for wading. The swimming pool is open from 9 a.m. until 7 p.m., 7 days a week.”

User: “Is it handicap accessible?”

Voice Assistant: “The pool is equipped with an ADA compatible swimming pool lift. Just ask for assistance where you pick up towels.”

In a second scenario involving the first configuration in Table 1, the user broaches the Swimming Pool topic with additional information. With the specific mention of the CI tag (“Pool”) together with the attribute associated with Component 2 (“Handicap Accessible”) in this scenario, the system understands that the Swimming Pool CI is to be invoked but the base description need not be provided, which gives the user an appropriate amount of information based on the specificity of their request, as in the interaction below:

User: “Is the pool handicap accessible?”

Voice Assistant: “The pool is equipped with an ADA compatible swimming pool lift. Just ask for assistance where you pick up towels.”

In situations where an administrator wishes to provide only brief descriptions in response to initial prompts or questions on a topic, components can be set to “Exclude,” or some other combination of flag settings can be used.

Table 2 below includes elements of a second configuration of the illustrative CI schema.

TABLE 2
Second Configuration

| Element | Value |
|---|---|
| CI Title | Anakeesta |
| CI Tags | Gondola |
| CI Base Description | “Enjoy a complimentary ride up the |
| | mountainside, with Anakeesta. One adult |
| | rides free to the top where zip lining, a |
| | treetop play area, gift shops, and other fun |
| | await you. Oh, and of course there are |
| | breathtaking views of the Smoky |
| | Mountains.” |
| CI Component 1 Attribute | Age Range |
| CI Component 1 | “Anakeesta is a great destination for all ages. |
| Description | There are options for everyone from just |
| | enjoying the incredible views, or high flying |
| | fun for thrill-seekers.” |
| CI Component 1 Include/ | Exclude |
| Exclude Flag | |
| CI Component 2 Attribute | Handicap Accessible |
| CI Component 2 | “There are several areas that are accessible to |
| Description | wheelchairs. Enjoy the shops at Firefly |
| | Village, the dining pavilion, viewing |
| | platforms, and scenic overlooks.” |
| CI Component 2 Include/ | Exclude |
| Exclude Flag | |
| CI Component 3 Attribute | Hours of Operation |
| CI Component 3 | “The hours of operation are 10am till 8pm.” |
| Description | |
| CI Component 3 Include/ | Exclude |
| Exclude Flag | |
| CI Component 4 Attribute | Parking |
| CI Component 4 | “There's a parking lot beside the ticket |
| Description | booth.” |
| CI Component 4 Include/ | Exclude |
| Exclude Flag | |
| CI Component 5 Attribute | Waiting Time |
| CI Component 5 | “By purchasing your tickets in advance with |
| Description | Xplorie, you can skip the line completely! |
| | There is a separate entrance just for prepaid |
| | people like you.” |
| CI Component 5 Include/ | Exclude |
| Exclude Flag | |
| CI Component 6 Attribute | Price |
| CI Component 6 | “Your stay here entitles you to one free adult |
| Description | admission. For ticket information, just ask, |
| | how do I get tickets.” |
| CI Component 6 Include/ | Exclude |
| Exclude Flag | |
| CI Component 7 Attribute | Lockers available |
| CI Component 7 | “There are no lockers available for your use |
| Description | at the top of Anakeesta, so plan on packing |
| | light.” |
| CI Component 7 Include/ | Exclude |
| Exclude Flag | |
| CI Component 8 Attribute | Open Year-Round |
| CI Component 8 | “It doesn't matter what time of the year you |
| Description | visit, Anakeesta is open year round.” |
| CI Component 8 Include/ | Exclude |
| Exclude Flag | |

In a first scenario involving the second configuration in Table 2, a user begins with a basic prompt about a topic, and then asks follow-up questions. The voice assistant notes the presence of the “Gondola” tag in the initial prompt from the user, invokes the “Anakeesta” CI, and responds with the base description. All components are set to “Exclude” in this configuration, but they can be invoked with corresponding attributes in follow up questions or prompts. Once the Anakeesta CI has been invoked, the system can respond to follow-up questions even where Anakeesta or “gondola” are not mentioned specifically, as in the interaction below.

User: “We're interested in a gondola ride”

Voice Assistant: “Enjoy a complimentary ride up the mountainside, with Anakeesta. One adult rides free to the top where zip lining, a treetop play area, gift shops, and other fun await you. Oh, and of course there are breathtaking views of the Smoky Mountains.”

User: “Is it handicap accessible?”

Voice Assistant: “There are several areas that are accessible to wheelchairs. Enjoy the shops at Firefly Village, the dining pavilion, viewing platforms, and scenic overlooks.”

User: “Is it good for teenagers?”

Voice Assistant: “Anakeesta is a great destination for all ages. There are options for everyone from just enjoying the incredible views, or high-flying fun for thrill-seekers.”

User: “How long are the lines?”

Voice Assistant: “By purchasing your tickets in advance with Xplorie, you can skip the line completely! There is a separate entrance just for prepaid people like you.”

User: “How much is it?”

Voice Assistant: “Your stay here entitles you to one free adult admission. For ticket information, just ask, how do I get tickets.”

In a second scenario involving the second configuration in Table 2, the user broaches the Anakeesta topic with additional information. With the specific mention of the CI tag (“Gondola”) together with attribute associated with Component 8 (“Open Year Round”) in this scenario, the system understands that the Anakeesta CI is to be invoked but the base description need not be provided, which gives the user an appropriate amount of information based on the specificity of their request while still providing the flexibility for providing further information in response to specific follow-up questions, as in the interaction below:

User: “Is there a gondola ride that is open year-round?”

Voice Assistant: “It doesn't matter what time of the year you visit, Anakeesta is open year-round.”

User: “Are lockers available?”

Voice Assistant: “There are no lockers available for your use at the top of Anakeesta, so plan on packing light.”

Another technical problem relates to the nature of voice assistants. One of the aspects of using voice to communicate with a knowledge system is a lack of visual cues to help a user that may not know how to proceed. With printed or on-screen information, it is possible to quickly scan and understand the scope of information available before asking a question. With a voice user interface, sometimes a user may not know what to ask or the capabilities of the system.

In embodiments described herein, a CI schema provides technical solutions to such problems. The ability to guide a user to specific recommendations that are appropriate for their situation removes the need for the user to understand all the options available. The illustrative schema outlined above, including the availability of attributes on CIs, can be used by a recommendation engine to address the problem. In an embodiment, attributes allow a range of possible recommendations to be narrowed by asking users what their preferences are. With attributes associated to CIs, a series of questions can be established that focus the recommendations that the voice assistant can deliver.

The following is an example of an interaction in a hospitality use case, leveraging a recommendation engine made possible by the CI schema as described above. In this example, a particular CI (such as the “Swimming Pool” or “Anakeesta” CIs described above) may have additional attributes such as “Outdoors”; “Time Duration”; “Physical Activity”; or the like.

User: “[Wake word], what's there to do around here?”

Voice Assistant: “By answering some questions, I can give you tailored suggestions for things to do. Would you like to do that?”

User: “Sure.”

Voice Assistant: “OK. To start things off, would you prefer something indoors or outdoors?”

User: “Outdoor.”

Voice Assistant: “How much time would you like to allocate? If 2 hours or less, say 1. If 2 to 4 hours, say 2. If more than 4 hours, say 3.”

User: “Two.”

Voice Assistant: “Alright. Based on your answers so far, I have 15 ideas for you. Would you like to hear them, or keep narrowing it down?”

User: “Keep going.”

Voice Assistant: “Alright. What is the right level of physical activity for those that are participating? Low, moderate or high?”

User: “Low or moderate.”

Voice Assistant: “Are you looking for something to do that is free, or are you open to all options?”

User: “Any option.”

Voice Assistant: “Based on that, I've got 7 options for you. Let's talk intensity now. Some things like are not physically demanding, but still get the adrenaline flowing. What level of intensity are you up for? relaxing, medium, or thrill-seeking?”

User: “Thrill-seeking”

Voice Assistant: “OK, thanks for giving me a good idea of what you are looking for. Based on your situation, I would recommend the following 3 options. The first one is Anakeesta. Say, ‘tell me more’ to hear about it, or say next to hear the next one.”

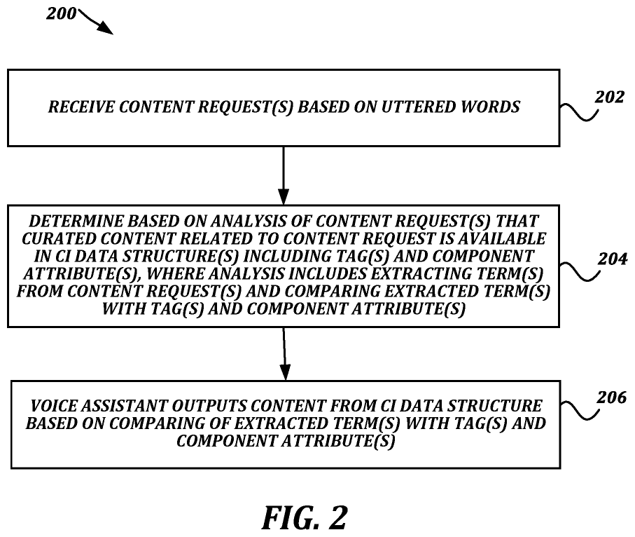

FIG. 2 is a flow chart of an illustrative process for obtaining curated voice content in response to content requests, in accordance with embodiments described herein. The process 200 may be performed by a computer system that implements one or more aspects of a voice-based information retrieval system 154, such as the system 100 or one or more components thereof.

The computer system has access to a database of curated content for responding to content requests. As used herein, the term “curated content” refers to any content that is authored, generated, or selected (e.g., by a property owner or host) for responding to content requests. Curated content may include answers to frequently asked questions about a property, instructions relating to features of the property, recommendations for off-property activities, or the like. Curated content may include host-authored content, content authored by others, and/or automatically generated content. Automatically generated content may be stored and approved or selected for future responses to content requests. Curated content may include text (which may in turn be converted to output in the form of synthesized voice output a voice assistant), images, video, audio, or any other type of content or combinations of content that may be useful for responding to content requests.

The process 200 begins at process block 202, in which the computer system receives a content request based on one or more uttered words (e.g., a question or prompt relating to a feature of a real property (e.g., a hotel, an apartment, a resort, a house, an event space, or a combination thereof) or an area in which the property is located). As used herein, the term “uttered words” refers to audio that includes words but is not limited to audible words spoken by a person. Uttered words also may include synthesized speech or any other type of audible words. In other embodiments, content requests may be based on other forms of expression, such as gestures detected by a camera-based gesture recognition system.

At process block 204, the computer system determines, based at least in part on analysis of the content request, that curated content related to the content request is available in a CI data structure. The CI data structure includes a tag and component attributes, examples of which are described in detail herein. The analysis of the content request includes extracting one or more terms from the content request and comparing the extracted term(s) with the tag and component attributes.

In an embodiment, a user provides voice input including one or more uttered words to a voice assistant 114 via the client device 102 (e.g., a smart speaker or smart phone), which interprets the voice input as a content request. The voice assistant 114 provides the content request to the voice-based information retrieval system 154, which performs the analysis of the content request. The analysis may include extracting one or more terms from the content request and comparing the extracted terms with available content in the curated content database. For example, the computer system may use speech-to-text processing to convert the second speech input to text and compare the resulting text with voice topic tags to determine if curated content is available to respond to the content request. Voice topic tags and illustrative uses thereof are described in further detail below.

At process block 206, the voice assistant outputs content from the CI data structure based at least in part on the comparing of the extracted term(s) with the tag and the component attributes. Illustrative content and processes of comparing extracted terms with tags and component attributes are described in detail herein.

The process 200 can be extended or modified to any number of content requests, and content requests of different types.

The process of matching content requests to available curated content can be performed in various ways. In some embodiments, voice topic tags can be used to disaggregate or decouple CIs from an NLU model. With voice topic tags, CIs do not need to be identified and pre-trained in the NLU model. Voice topic tags act as an intermediary, a separate entity that connects unique custom content to a set of words and phrases that are part of the NLU model. This approach allows the system to provide a natural-feeling conversation for the user, while also providing the flexibility to present custom content to a user without specialized NLU training. This approach also provides a significant increase in flexibility and utility. The NLU engine is pre-trained on a set of words and phrases, and a voice topic tag is connected to that set of words and phrases in the model. It is also connected to a custom CI defined by a property host or other administrator or author. By establishing these connections, a word or phrase of the set that is spoken by the user will result in the associated CI being delivered in response. This creates broad flexibility and utility for a host, allowing them to establish CIs that do not need to be included in the NLU model, in such a way that unique content (including proper nouns) can be delivered to a user through a voice assistant with no NLU training required. Multiple voice topic tags can be associated with a single CI. Similarly, a given voice topic tag can be used for multiple CIs.

Consider a scenario in which a host has a favorite family-friendly restaurant called “Bubba's Place” that also features games for kids. Using voice topic tags, a host may choose to tag content describing Bubba's Place with voice topic tags such as “restaurant” and “kids.” It will be possible for a user looking for a restaurant recommendation to access the Bubba's place content (e.g., by asking “Can you recommend a good restaurant?”) just as easily as a different user looking for kids' activities (e.g., “Tell me about activities for kids”). Yet, the system need not be specially programmed to provide information about Bubba's Place in response to questions about kid's activities or restaurants, or to provide a specific menu structure for restaurant recommendations or kids' activities. Instead, the “restaurant” and “kids” voice topic tags need only be applied to the content to allow it to be discovered by these two users. Further, voice topic tags can be defined to include synonyms or related concepts. For example, the host may tag an on-property CI titled “Garbage and Recycling” with a “garbage” voice topic tag, which may be defined such that the words “garbage,” “trash,” “recycling,” “composting,” “refuse,” and “rubbish” will all be recognized in a user's inquiry. In an illustrative scenario, a guest could say either “What do I do with the trash?” or “Give me information about recycling,” and in either case, the “Garbage and Recycling” CI will be provided.

### Techniques for Scaling Large Deployments of Voice Content

Other technical problems relate to the difficulty of scaling large deployments of voice content. As implementations of voice assistants providing curated content scale to hundreds or thousands of units, the management of voice content becomes more difficult. The larger the deployment, the more people are involved in management of the content. Further, certain voice content is appropriate for just one device location, and other voice content is appropriate for multiple device locations, or all device locations. The larger the number of device locations, the more possible combinations of voice content items and device locations there are, and the greater the management challenge.

A further problem exists around the re-use of voice content. For example, imagine a scenario where a mechanism is established to allow a set of CIs to be cascaded from a single source out to many device locations. This mechanism can be deployed many times, and at many levels. In such implementation, a given CI may be arranged together with a variety of other CIs and assigned to a set of device locations. This may be repeated across many possible combinations of CIs, where the same definition exists for the given CI, however the collection of CIs is unique each time. In such an implementation, managing any changes to the definition of that CI is problematic. An administrator must individually edit the definition of that CI in all the various sets of CIs that have been created which include that CI. The larger the implementation becomes, the greater the difficulty in managing the voice content.

It is also important at large scale for a higher-level administrator to be able to delegate ownership to lower-level administrator. This is true for any number of Administration levels. An issue inherent to this situation with voice content is that higher level administrators may want to control the content associated with a given topic across many device locations, or all device locations. Without a mechanism to establish the relative priority of CIs, there is no way of controlling the content package delivered to the devices in the device locations controlled by the lower-level administrator.

In embodiments described herein, a system employing a CI schema provides technical solutions to such problems using a model that provides for the effective and efficient management of voice content at large scale. In an embodiment described in further detail below, the model provides RBAC permissions to any number of administrators at any level. It also allows voice content to be cascaded down and across many device locations, so that changes to a CI in a single container can be propagated automatically, with no additional administrative burden. Further, it enables many containers to include the same CI in a design by which that CI can be managed as a single entity. In addition, it establishes a means by which higher-level administrators can supersede the content definition of lower-level administrators without having to manually review and correct voice content that is not aligned with their objectives. Illustrative containers and other concepts relating to such embodiments are described in further detail below.

An illustrative design for multi-level management of voice content that solves inherent problems and enables unique capabilities when managing voice content at large scale will now be described. Elements of the illustrative design include content management domains (or “Groups”), containers, and categories.

In some embodiments, a content management domain that contains a set of containers and categories provides a mechanism by which many different organizations can all contribute toward the full set of content that gets delivered through a given device. This mechanism is particularly useful for scaling to large scale deployments of devices. In an implementation at large scale, it is often desirable to provide different content creation or management teams their own permission structure to be able to contribute content, and also have a hierarchy defined so that organizations with higher priority can publish content in their container that will overwrite or take precedence over content from a lower priority team if they both contribute content on a given topic.

In this illustrative design, for each instance of a hierarchy that is established for the management of voice content for a set of devices, a content management domain or “Group” is defined that has a top-level administrator, as well as any number of lower-level administrators that are assigned permissions in a Role Based Access Control (RBAC) methodology. A given administrator may be designated as the owner of a set of devices and granted permission to create and manage content for those devices.

In this illustrative design, a container is a logical construct that assembles a set of CIs. Containers belong to a content management domain Each container has a priority relative to one another within that content management domain.

In this illustrative design, category data structures (also referred to herein as “categories”) are used to define the structure and organization of a group. A category tree is a hierarchy of categories. In a category tree, there is a top-level category for a content management domain, and then child categories below it, and second level child categories below that, progressing down any given branch. A category tree can have any number of levels in any branch of the tree.

Categories each have a permission role associated with them, which then allows a given administrator access to that category if they are assigned to that role. Roles that are established at a higher-level category automatically are inherited by all child categories.

Categories may have containers associated with them. A given category may have no containers, one, or many.

A category may also have device locations associated with it. In an embodiment, this is true only if the category does not have child categories. The CIs inside a container that is assigned to a category are available to all device locations assigned to categories at or below the category to which it is assigned. However, this does not necessarily mean a given CI will be included in the content package for the device location. In an embodiment, the inclusion of a CI in the content package is dictated by whether there is a conflict with any CIs that are in a higher-level container. If so, the CI in the higher-level container will supersede the lower level.

Other aspects of the design relate to a mechanism to provide global voice content.

As described in the problem statement above, even with the system in place that allows CIs to be organized into any number of containers, there is a remaining problem. Multiple containers may include the same given CI. An example of this in a hospitality use case is a given restaurant represented by a CI that needs to be included in containers that are set up for each hotel in the area, respectively. If a change is necessary to the description of the restaurant, it becomes a data management problem to have to make the same change across many containers. Instead, what is needed is the ability to manage the singular definition of a CI in such a way that use of a CI across any number of containers can be done easily and efficiently.

In an embodiment, Global CIs are introduced to provide such a capability. With global voice content management, a collection of special Global CIs may be defined by an administrator in a separate arrangement. Then an administrator can choose one or more Global CIs from this collection to add to a container. In such a way, any container in a content management domain may include Global CIs. In an embodiment, when modification of the definition of a Global CI is desired or needed, it is done from a single source. That change is then propagated across all containers which reference that Global CI. This system solves the scaling problem related to the re-use of voice content.

Other aspects of the design relate to a voice content publishing process. In an illustrative scenario, in a large organization managing thousands of units (e.g., hotel rooms or rental properties), it is possible for dozens or even hundreds of category levels to be defined. At the lowest level category, a given unit assigned to that category must now have all the CIs across all containers, with each of their relative priorities considered, to be aggregated together into a single content package. In this illustrative scenario, this is necessary because the response time associated with a voice interaction with a user must be extremely fast. It is not possible to perform the logic steps and computation necessary to build a content package at run time (when a dialog is happening with a user). Therefore, the illustrative design includes a process by which an administrator can make a change to the voice content at any level of the category tree, and then initiate a Publish event.

The Publish process aggregates all the CIs, and enforces the prioritization defined by the administrators. The result is a content package that is a lightweight, text-based object that can be passed to the software endpoint responsible for controlling the dialog with the user.

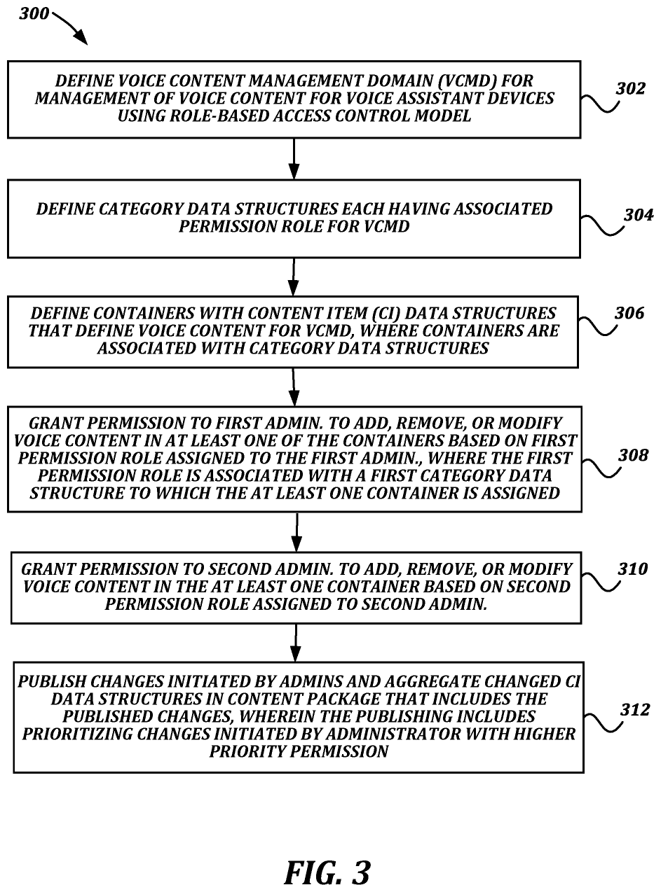

FIG. 3 is a flow chart of an illustrative process for management of voice content for voice assistant devices using a role-based access control model in accordance with embodiments described herein. The process 300 provides for effective and efficient management of voice content at large scale in accordance with design principles described herein. The process 300 may be performed by a computer system that implements a voice-based information retrieval system 154, such as the system 100 or one or more components thereof.

The process 300 begins at process block 302, in which the computer system defines a voice content management domain for management of voice content for voice assistant devices using a role-based access control model. At process block 304, the computer system defines category data structures (which also may be referred to as “categories”) each having associated permission roles for the voice content management domain (VCMD). At process block 306, the computer system defines containers with CI data structures that define voice content for the VCMD. The containers are associated with the category data structures. At process block 308, the computer system grants permission to a first administrator to change (e.g., add, remove, or modify) voice content in at least one of the containers based on a first permission role assigned to the first administrator. The first permission role is associated with a first category data structure to which the at least one container is assigned. The association of the first permission role with the first category data structure may be realized in different ways, e.g., from the first permission role being assigned directly to the first category data structure, or from inheriting the permission role from a higher-level category, as explained in further detail below.

From this point, it is possible for the computer system to then publish one or more changes initiated by the first administrator in one or more of the CI data structures and aggregate the changed CI data structure(s) in a content package that includes the published change(s) for one or more of the voice assistant devices.

However, in the example shown in FIG. 3, the process continues in such a way that a second administrator (e.g., from a different organization and/or having a different permission role) can also be allowed to change voice content in the at least one container. At process block 310, the computer system grants permission to the second administrator to change (e.g., add, remove, or modify) voice content the at least one container based on a second permission role assigned to the second administrator. At process block 312, the computer system publishes changes by the first and second administrators and aggregates changed CI data structures in a content package that includes the published changes. In this example, the publishing of the changes includes prioritizing changes initiated by the administrator with a higher-priority permission role.

In some embodiments, the computer system defines a category tree for the voice content management domain. The category tree defines a hierarchy of the category data structure. In some embodiments, the hierarchy includes multiple levels, and permission roles associated with the category data structures in higher levels are inherited by category data structures in lower levels.

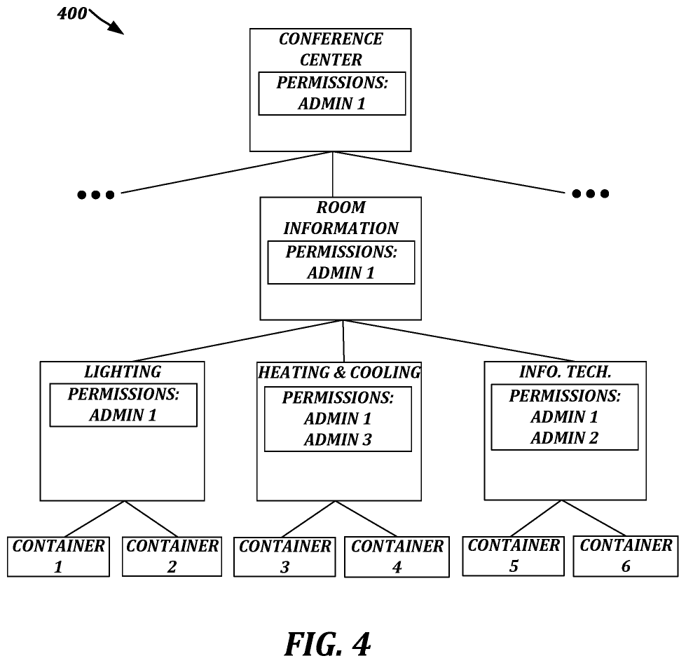

In an illustrative category tree 400 depicted in FIG. 4, a top-level administrator affiliated with a conference center is assigned a permission role associated with a top-level category (“Conference Center”) of a voice content management domain relating to voice content that provides information to conference room users. Conference Center has multiple child categories, including “Room Information.” “Room Information” has one level of child categories below it, including “Lighting,” “Heating and Cooling,” and “Information Technology.” “Lighting,” “Heating and Cooling,” and “Information Technology” each have two containers associated with them. “Conference Center” and “Room Information” do not have any containers associated directly with them, but the top-level permission role associated with “Conference Center” grants the top-level administrator (“Admin 1”) permission to change voice content in all the containers associated with the child categories of “Conference Center” including the child categories of “Room Information,” i.e., “Lighting,” “Heating and Cooling,” and “Information Technology.” A second administrator (“Admin 2”) affiliated with an IT services provider is assigned a permission role associated with “Information Technology.” A third administrator (“Admin 3”) affiliated with a heating and cooling contractor is assigned a permission role associated with “Heating and Cooling.” The permission roles associated with “Information Technology” and “Heating and Cooling,” respectively, grant the second administrator and third administrator permission to change voice content only for the two containers associated with that category but no others. In addition, any change specified by the top-level administrator for the containers associated with “Information Technology” or “Heating and Cooling” will supersede any conflicting changes specified by the other administrators, due to the top-level administrator's higher-priority permission role. This design allows the first administrator to outsource responsibility for changes to some voice content to other administrators, who may have greater expertise in the content they are responsible for. In this example, this may include allowing an IT services contractor to make changes to voice content relating to networking equipment, WiFi passwords, audio/visual equipment, or the like, when the IT services contractor makes changes to those resources. On the other hand, this design still allows the top-level administrator to supersede those changes as needed.

In some embodiments, as an additional tool for managing voice content, the containers include a reference to at least one global CI data structure. In such embodiments, changes to the global CI data structure that originate from a single source may be propagated across all containers that reference the global CI data structure.

### Techniques for Creating Dynamic Voice Menus

Another technical problem relates to the difficulties of creating voice menus. As mentioned above, without visual prompts, voice user interfaces lack the ability for a user to scan a menu and see what the system has to offer. In addition to the techniques described above relating to progressively narrowing potential topics of interest, another approach is described in U.S. Pat. No. 10,860,289, which is incorporated herein by reference.

Although it is possible to automatically generate a menu of options that can be delivered via a voice user interface, there are problems inherent to the implementation of such a design. To create a menu of options, a VCMP takes whatever CIs are created by an administrator and organize them to present to a user. If administrators have the flexibility to add many CIs, it is difficult to fit any set of CIs into a single voice menu structure. If a small menu structure is established and an administrator adds many CIs, a situation arises where there are too many topics covered under one menu choice. In this case the user waits for the voice assistant to convey a long list of options under that single menu choice, leading to a poor experience. Conversely, consider the case where a large menu structure is defined that can accommodate many CIs comfortably. If a particular unit only requires a few options and an administrator sets it up that way, now the user must navigate through multiple levels of a menu structure to eventually get to a level at which content can be delivered. Again, this results in a poor user experience.

One design choice that could be made for a VCMP is to allow an administrator to set up a custom structure that is adapted to the size of the content set. The problem with this approach is that it adds a significant administrative burden. Determining the right structure can be a time-consuming process. This is especially true if the size of the content set changes over time, and the structure must then be adapted.

In embodiments described herein, an automated approach that dynamically adjusts to a specific content package provides one or more technical solutions to such problems. In embodiments described in further detail below, it is possible to have a standardized and automated approach to establishing the structure of a set of voice menu options. At the same time, such embodiments allow that structure to automatically adapt to a specific voice content set. This results in low administration overhead, and a positive user experience without compromising one at the expense of the other.

A dynamic voice menu structure is one that can adapt to both large and small content sets. In an embodiment, the approach to establish this construct is as follows.

A set of tags are defined for an industry implementation, such as hospitality, senior living, or real estate. Each tag is assigned a tag category (TC). Each TC is assigned a parent TC to aggregate similar options into higher level groupings. In this way, a Voice Menu Tree (VMT) is established. If a TC is the parent of another TC, no tags may also be assigned to it. With this rule, CIs with tags are only presented at the leaf level of the VMT. A process called Menu Folding is then performed for a given content set. In an embodiment, the Menu Folding process proceeds as follows:
1) The folding begins at the leaf level of the menu structure. Any leaf-level TC that does not have a CI with a tag that belongs to that TC is removed from the menu structure.
2) The remaining leaf-level TCs are organized by their sibling groups. Sibling TCs have the same parent TC. The CIs are counted across each sibling group. If the total number of CIs is 3 or less, those CIs are assigned to the parent, and all the child TCs in that group are removed from the menu structure.
3) There are now new leaf-level TCs in the menu structure. Step 1 is repeated, since if all siblings under a given parent were removed in the prior step, then the parent which is now at the leaf level can be removed. Then step 2 is repeated. Continue this process until the there are no eligible TCs to remove.

The resulting voice menu structure follows a standard best practice design but is sized appropriately for the number of CIs in any given branch of the structure, as well as the structure overall.

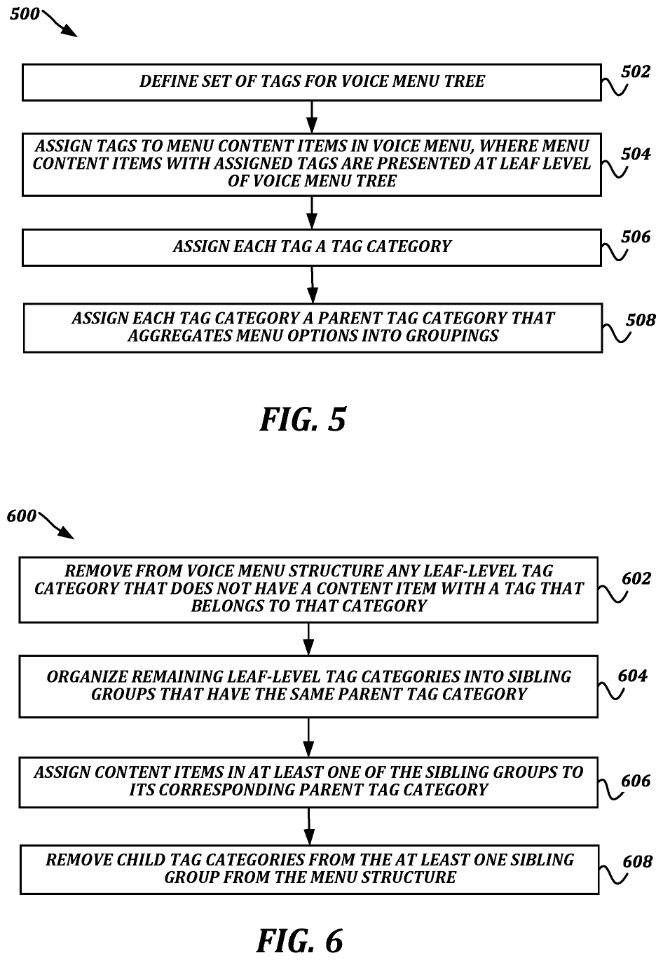

FIGS. 5 and 6 are flow charts of illustrative processes for defining and adjusting a dynamic voice menu structure, respectively, in accordance with embodiments described herein. The processes 500 and 600 may be performed by a computer system that implements a voice-based information retrieval system 154, such as the system 100 or one or more components thereof.

Turning first to the process 500 for defining the voice menu structure, at process block 502 the computer system defines a set of tags for a voice menu tree. At process block 504, the computer system assigns at least some of these tags to menu CIs in a voice menu. The menu CIs to which the tags are assigned are presented at leaf level of the voice menu tree. At process block 506, the computer system assigns each tag a tag category, and at process block 508, the computer system assigns each tag category a parent tag category that aggregates menu options into groupings.

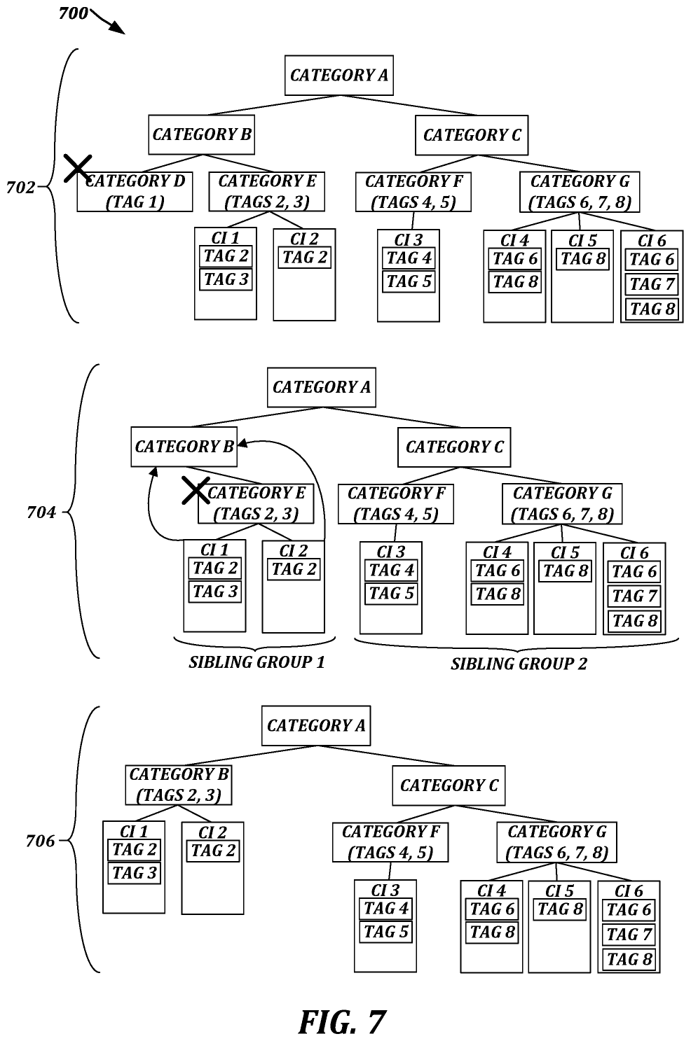

Having initially defined the voice menu structure in this way, the computer system is then able to automatically adjust this structure for improved efficiency. FIG. 7 is a diagram depicting an illustrative voice menu structure 700. In a first state 702, the voice menu structure includes leaf-level categories D, E, F, and G for tags 1-8. Tag 1 is assigned to Category D, tags 2 and 3 are assigned to Category E, tags 4 and 5 are assigned to Category F, and tags 6, 7, and 8 are assigned to Category G. There are two CIs (CI 1, CI 2) with tags from Category E, one CI (CI 3) with tags from Category F, three CIs (CI 4, CI 5, CI 6) with tags from Category G. There are no CIs with tags from Category D.

Turning now to the illustrative process 600, at process block 602 the computer system removes from the voice menu structure any leaf-level tag category that does not have a CI with a tag that belongs to that category. This is illustrated in FIG. 7 at state 702, in which Category D is marked for deletion with an “X”.

At process block 604, the computer system organizes the remaining leaf-level tag categories into sibling groups that have the same parent tag category. At process block 606, the computer system assigns CIs in at least one of those sibling groups to its corresponding parent tag category and, at process block 608, the computer system removes any child (leaf-level) tag categories in the at least one sibling group from the menu structure. In an embodiment, the computer system determines how many CIs are in each sibling group and, if the total number of CIs in that sibling group is 3 or less, the CIs from that sibling group are assigned to the parent tag category and the leaf-level tag categories in that sibling group are removed. These steps are illustrated in FIG. 7 in states 704 and 706, in which Category E of Sibling Group 1 is deleted and its CIs (CI 1, CI 2) are assigned to parent Category B, whereas Sibling Group 2 is unchanged.

Techniques for Managing Voice Content that Changes

Another technical problem relates to reducing the overhead of managing voice content that changes. Some voice content can be created once and does not require changes over time. However, other topics delivered through voice may be variable or transient. Examples include:
Daily meal plans at a senior living facility.
A completely different set of topics to provide information about at a ski resort in the summertime vs the winter.
An annual festival, where the voice content description of the festival is only applicable once a year.
A schedule of local entertainment and events that is updated monthly.
“This day in history” or other daily facts or trivia, or self-development content that changes constantly.

Maintaining this type of dynamic content is time consuming and may be a barrier to adoption of voice assistants delivering curated content for these types of use cases.

In embodiments described herein, a CI schema provides technical solutions to such problems. In an embodiment, a CI schema includes an illustrative element outlined below. With a scheduling engine incorporated into the structure of a CI, administrators can efficiently handle voice content that changes periodically. When topics are recurring, they can be set up once. When topics change frequently, they can be added all at one time instead of making the changes on each effective date. By eliminating redundant work and allowing tasks to be accomplished in bulk, significant efficiencies can be realized.

In an embodiment, for scheduled activation, a CI has the optional capability to provide an effective date range to prescribe when it should be activated. A scheduling engine is employed to set both the scheduled period for activation, as well as any recurrence that may be appropriate. For example, a CI may be activated on Tuesdays every week, or the third Monday of every month, or annually on September 10-15, or from 8 a.m. to 12 p.m. daily, or on some other schedule.

### Illustrative Operating Environments

Unless otherwise specified in the context of specific examples, described techniques and tools may be implemented by any suitable computing device or set of devices.

In any of the described examples, an engine may be used to perform actions. An engine includes logic (e.g., in the form of computer program code) configured to cause one or more computing devices to perform actions described herein as being associated with the engine. For example, a computing device can be specifically programmed to perform the actions by having installed therein a tangible computer-readable medium having computer-executable instructions stored thereon that, when executed by one or more processors of the computing device, cause the computing device to perform the actions. The particular engines described herein are included for ease of discussion, but many alternatives are possible. For example, actions described herein as associated with two or more engines on multiple devices may be performed by a single engine. As another example, actions described herein as associated with a single engine may be performed by two or more engines on the same device or on multiple devices.

In any of the described examples, a data store contains data as described herein and may be hosted, for example, by a database management system (DBMS) to allow a high level of data throughput between the data store and other components of a described system. The DBMS may also allow the data store to be reliably backed up and to maintain a high level of availability. For example, a data store may be accessed by other system components via a network, such as a private network in the vicinity of the system, a secured transmission channel over the public Internet, a combination of private and public networks, and the like. Instead of or in addition to a DBMS, a data store may include structured data stored as files in a traditional file system. Data stores may reside on computing devices that are part of or separate from components of systems described herein. Separate data stores may be combined into a single data store, or a single data store may be split into two or more separate data stores.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client is receiving information provided by a server at a remote location. Alternatively, a peer-to-peer arrangement, or other models, can be used.

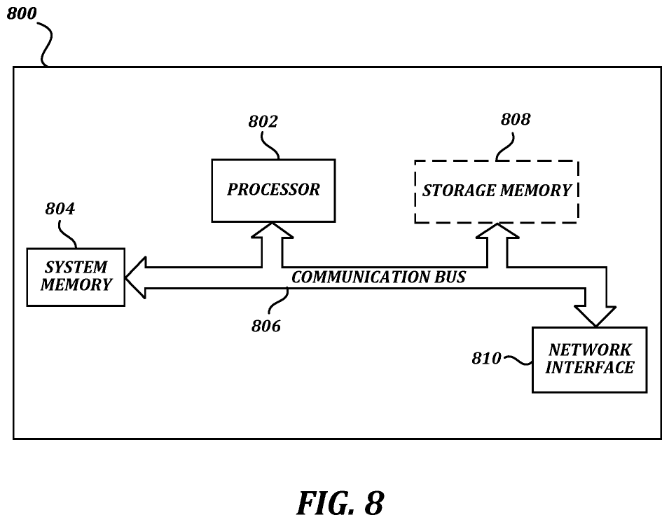

FIG. 8 is a block diagram that illustrates aspects of an illustrative computing device 800 appropriate for use in accordance with embodiments of the present disclosure. The description below is applicable to servers, personal computers, mobile phones, smart phones, tablet computers, embedded computing devices, and other currently available or yet-to-be-developed devices that may be used in accordance with embodiments of the present disclosure.

In its most basic configuration, the computing device 800 includes at least one processor 802 and a system memory 804 connected by a communication bus 806. Depending on the exact configuration and type of device, the system memory 804 may be volatile or nonvolatile memory, such as read only memory (“ROM”), random access memory (“RAM”), EEPROM, flash memory, or other memory technology. Those of ordinary skill in the art and others will recognize that system memory 804 typically stores data and/or program modules that are immediately accessible to and/or currently being operated on by the processor 802. In this regard, the processor 802 may serve as a computational center of the computing device 800 by supporting the execution of instructions.

As further illustrated in FIG. 8, the computing device 800 may include a network interface 810 comprising one or more components for communicating with other devices over a network. Embodiments of the present disclosure may access basic services that utilize the network interface 810 to perform communications using common network protocols. The network interface 810 may also include a wireless network interface configured to communicate via one or more wireless communication protocols, such as WiFi, 2G, 3G, 4G, LTE, 5G, WiMAX, Bluetooth, and/or the like.

In FIG. 8, the computing device 800 also includes a storage medium 808. However, services may be accessed using a computing device that does not include means for persisting data to a local storage medium. Therefore, the storage medium 808 depicted in FIG. 8 is optional. In any event, the storage medium 808 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like.

As used herein, the term “computer-readable medium” includes volatile and nonvolatile and removable and nonremovable media implemented in any method or technology capable of storing information, such as computer-readable instructions, data structures, program modules, or other data. In this regard, the system memory 804 and storage medium 808 depicted in FIG. 8 are examples of computer-readable media.

For ease of illustration and because it is not important for an understanding of the claimed subject matter, FIG. 8 does not show some of the typical components of many computing devices. In this regard, the computing device 800 may include input devices, such as a keyboard, keypad, mouse, trackball, microphone, video camera, touchpad, touchscreen, electronic pen, stylus, and/or the like. Such input devices may be coupled to the computing device 800 by wired or wireless connections including RF, infrared, serial, parallel, Bluetooth, USB, or other suitable connection protocols using wireless or physical connections.

In any of the described examples, input data can be captured by input devices and processed, transmitted, or stored (e.g., for future processing). The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 800 (e.g., a client device), or can be integral components of the computing device 800. In some embodiments, multiple input devices may be combined into a single, multifunction input device (e.g., a video camera with an integrated microphone). The computing device 400 may also include output devices such as a display, speakers, printer, etc. The output devices may include video output devices such as a display or touchscreen. The output devices also may include audio output devices such as external speakers or earphones. The output devices can be separate from and communicatively coupled to the computing device 800, or can be integral components of the computing device 800. Input functionality and output functionality may be integrated into the same input/output device (e.g., a touchscreen). Any suitable input device, output device, or combined input/output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, Python, Ruby, HTML, CSS, JavaScript, VBScript, ASPX, Microsoft .NET™ languages such as C#, and/or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

### Extensions and Alternatives

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Although illustrative embodiments are described with reference to a voice-enabled smart speaker and a voice-based information retrieval system, it should be understood that the devices and systems described herein need not be limited to voice or audio input and output. An information retrieval system that responds to voice input may be considered “voice-based” without being strictly limited to voice input or voice output. Thus, suitable client devices and administrator devices may include smart phones or other computing devices with touchscreens, video display functionality, and other features. For client devices with video display capability, a user may be presented with video content such as a welcome video or an instructional video, e.g., in response to selection of menu options. The portal may be augmented to provide administrators the ability to upload images, videos, audio files, or other media as custom content. In addition, smart speakers with touchscreen and video display functionality are contemplated, as well as other user interface devices such as virtual reality devices, which may include headsets paired with corresponding handheld devices or other input/output devices. At a suitably configured client device, a user may be provided with ability to, for example, point to, swipe, tap, or use some other action or gesture to interact with images representing menu items (e.g., things to do in the area), either in place of or in combination with navigating and selecting items with voice input. Similar capabilities can be incorporated in an administrator device, to provide administrators with additional options for customizing the system and providing custom content. As with a voice interface, an enhanced user experience with visual, touch, or virtual reality aspects is possible without the complexity of reprogramming or retraining the information retrieval system, in accordance with principles described herein.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

Many alternatives to the user interfaces described herein are possible. In practice, the user interfaces described herein may be implemented as separate user interfaces or as different states of the same user interface, and the different states can be presented in response to different events, e.g., user input events. The user interfaces can be customized for different devices, input and output capabilities, and the like. For example, the user interfaces can be presented in different ways depending on display size, display orientation, whether the device is a mobile device, etc. The information and user interface elements shown in the user interfaces can be modified, supplemented, or replaced with other elements in various possible implementations. For example, various combinations of graphical user interface elements including text boxes, sliders, drop-down menus, radio buttons, soft buttons, etc., or any other user interface elements, including hardware elements such as buttons, switches, scroll wheels, microphones, cameras, etc., may be used to accept user input in various forms. As another example, the user interface elements that are used in a particular implementation or configuration may depend on whether a device has particular input and/or output capabilities (e.g., a touchscreen). Information and user interface elements can be presented in different spatial, logical, and temporal arrangements in various possible implementations.

While illustrative embodiments have been illustrated and described, it will be appreciated that various changes can be made therein without departing from the spirit and scope of the invention.

The embodiments of the invention in which an exclusive property or privilege is claimed are defined as follows:

1. A computer system having at least one processor and non-transitory computer-readable media having stored thereon instructions configured to cause the computer system to perform steps comprising:
defining a voice content management domain for management of voice content for voice assistant devices using a role-based access control model;
defining category data structures each having an associated permission role for the voice content management domain;
defining containers with content item data structures that define the voice content for the voice content management domain, wherein the containers are associated with the category data structures; and
granting permission to a first administrator to add, remove, or modify the voice content in at least one of the containers based on a first permission role assigned to the first administrator, wherein the first permission role is associated with a first category data structure to which the at least one container is assigned.

2. The computer system of claim 1, wherein the instructions are further configured to cause the computer system to publish a change in one or more of the content item data structures and aggregate the content item data structures in a content package that includes the published change for one or more of the voice assistant devices.

3. The computer system of claim 1, wherein the instructions are further configured to cause the computer system to grant permission to a second administrator to add, remove, or modify the voice content in the at least one container based on a second permission role assigned to the second administrator.

4. The computer system of claim 3, wherein the instructions are further configured to cause the computer system to publish changes initiated by the first administrator and the second administrator in one or more of the content item data structures and aggregate the content item data structures in a content package that includes the published changes for one or more of the voice assistant devices.

5. The computer system of claim 4, wherein the publishing of the changes includes, in a case where the permission granted to the first administrator is higher priority than the permission granted to the second administrator, prioritizing changes initiated by the first administrator over changes initiated by the second administrator.

6. The computer system of claim 3, wherein the first administrator and the second administrator are in different organizations.

7. The computer system of claim 1, wherein the instructions are further configured to cause the computer system to define a category tree for the voice content management domain, wherein the category tree defines a hierarchy of the category data structures.

8. The computer system of claim 7, wherein the hierarchy includes at least a first level and a second level higher than the first level, and wherein the permission roles associated with the category data structures in the second level are inherited by the category data structures in the first level.

9. The computer system of claim 1, wherein the containers include a reference to at least one global content item data structure, and wherein changes to the global content item data structure that originate from a single source are propagated across all containers that reference the global content item data structure.

10. A method comprising, by a computer system having access to a database of curated content:
receiving, via a voice assistant, a first content request based on uttered words;
determining, based at least on part on analysis of the first content request, that curated content related to the first content request is available in a content item data structure, wherein the content item data structure includes one or more tags and one or more component attributes, and wherein the analysis of the first content request includes extracting terms from the first content request and comparing the extracted terms with the one or more tags and component attributes; and
outputting, by the voice assistant, content from the content item data structure responsive to the first content request based at least in part on the comparing of the extracted terms with the one or more tags and component attributes.

11. The method of claim 10 further comprising:
selecting content associated with the one or more component attributes for inclusion in the outputted content.

12. The method of claim 11, wherein the outputted content includes one or more component descriptions associated with the one or more component attributes.

13. The method of claim 12, wherein the outputted content further includes a base description of the content item data structure.

14. The method of claim 10 further comprising:
receiving, via the voice assistant, a second content request;
extracting terms from the second content request;
comparing the extracted terms from the second content request with the component attributes; and
outputting content associated with the component attributes responsive to the second content request.

15. The method of claim 10, wherein the first content request is prompted by a recommendation engine of the voice assistant.

16. The method of claim 10, wherein the voice assistant has not been previously trained for natural language understanding (NLU) of the first content request.

17. The method of claim 10, wherein the voice assistant is implemented in a mobile computing device or a voice-enabled speaker.

18. A computer system comprising one or more computing devices programmed to implement a dynamic voice menu structure, wherein the computer system is programmed to:
implement a voice menu tree by defining a set of tags for menu content items, assigning each tag a tag category, and assigning each tag category a parent tag category that aggregates menu options into groupings, wherein menu content items with the tags are presented at leaf level of the voice menu tree; and
execute a menu folding process that includes removing from the menu structure any leaf-level tag category that does not have a menu content item with a tag that belongs to that tag category.

19. The computer system of claim 18, wherein the menu folding process further includes organizing remaining leaf-level tag categories into sibling groups that have the same parent tag category, assigning content items in at least one of the sibling groups to its corresponding parent tag category, and removing one or more child tag categories from the at least one sibling group from the menu structure.

20. The computer system of claim 19, wherein the steps of assigning the content items in the at least one sibling group to its corresponding parent tag category and removing the one or more child tag categories from the menu structure are performed in response to comparing the number of content items in the at least one sibling group with a threshold number.
